(19) United States
(12) Patent Application Publication
(10) Pub. No.: US 2005/0220229 A1
(43) Pub. Date: Oct. 6, 2005

(54) Synchronization acquisition circuit and receiving apparatus using the same

(75) Inventor: Shoji Goto, Gifu-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/088,721

(22) Filed: Mar. 25, 2005

(30) Foreign Application Priority Data
Mar. 30, 2004 (JP) 2004-098635

(51) Int. Cl. H04L 27/06

(52) U.S. Cl. 375/343

(57) ABSTRACT

A matched filter is provided with a plurality of taps and calculates correlations between a baseband signal and a diagnosis signal series. The matched filter derives the diagnosis signal series, based on the first through fourth preamble patterns that are candidates for a match with a preamble pattern included in the baseband signal. A hopping pattern detection unit averages the correlations output from the matched filter for each symbol. The hopping pattern detection unit generates and analyzes delay profiles so as to detect a frequency hopping pattern. A symbol timing detection unit averages the correlations output from the matched filter over the symbols. The symbol timing detection unit generates and analyzes delay profiles so as to detect symbol timing in steps.

### BACKGROUND OF THE INVENTION

1. Field of the Invention

The present invention relates to a synchronization acquisition technology and, more particularly, to a synchronization acquisition circuit which captures a predetermined pattern included in an input signal and a receiving apparatus using the circuit.

2. Description of the Related Art

In the field of wireless communication, study has been conducted on the use of spread spectrum (SS) communication scheme. The spread spectrum communication scheme encompasses a direct sequence (DS) scheme and a frequency hopping (FH) scheme. In the FH scheme, spread spectrum communication is performed by hopping between carrier frequencies in accordance with a series of codes. The spectrum according to the FH occupies a wide frequency band under a long-term observation. However, a bit or a symbol under observation reveals itself as a signal of a narrower band than a DS signal, occupying only a specific frequency band. It is due to this aspect that the FH scheme is called an SS system adapted for avoidance of interference. The FH scheme as such is advantageous in that the probability of a plurality of users communicating in the same frequency at the same time is reduced. Generally, the frequency band of a transmitted signal is determined according to a predetermined frequency hopping pattern. The receiving end does not have prior knowledge as to which of a plurality of frequency hopping patterns is used and as to the timing schedule in which the pattern is received. Therefore, there is a need to establish synchronization both in a time domain and in a frequency domain using synchronization acquisition.

According to one technology for synchronization acquisition, a wideband received signal covering the entirety of channels in the FH scheme is examined so as to estimate a received channel by digital signal processes such as FFT (See reference (1) in the following Related Art List, for instance). In this technology, there is provided a frequency detection unit which detects a frequency hopping pattern based on detected frequencies. By integrating an output from the frequency detection unit, a point of change in the frequency pattern is identified to establish timing synchronization. In this scheme, however, the frequency band in which thermal noise is received is also extended as a result of the received band being extended. Therefore, the receiving sensitivity drops. In the above related-art technology, the frequency detection unit is comprised of an FFT unit and a DFT filter bank which is composed of an FFT unit and a filter bank for multi-rate signal processing. The resultant synchronization acquisition circuit, including provisions for timing detection, is relatively complex.

In another known technology for synchronization acquisition, only a signal in a specific frequency band is received. A pattern indicating presence and absence of signal is compared with a plurality of frequency hopping patterns preset in a system (See reference (2) in the following Related Art List, for instance). In this technology, there is provided a band-pass filter (BPF) transmitting frequency components monitored by the synchronization acquisition circuit and outputting the transmitted components. A determination circuit determines as to whether any signal occurs in the transmitted frequency band and outputs a result of determination as a signal presence and absence pattern to a pattern comparison circuit. The pattern comparison circuit outputs a pattern that matches those portions of transmitting-end frequency hopping pattern within the frequency range monitored by the synchronization acquisition circuit, as a synchronization pattern.

The pattern comparison circuit compares the signal presence and absence pattern from the determination circuit with the synchronization pattern to determine if they match. When it is determined that there is a phase difference between the signal presence and absence pattern and the synchronization pattern, a determination that the signal presence and absence pattern matches the synchronization pattern is still made if there is a match in the format of pattern. When the signal presence and absence pattern matches the synchronization pattern, synchronization acquisition is performed through predetermined processes. In the described scheme, the structure of a frequency hopping pattern detection circuit is simplified. However, detection precision is degraded in a situation in which field intensity varies significantly due to multipath, since a determination is made only on the signal level. Further, it is presumed that symbol timing detection according to this structure is difficult since a relatively large error is produced.

### RELATERD ART LIST

(1) Japanese Patent Application Laid-Open No. Hei11-251969.
(2) Japanese Patent Application Laid-Open No. 2003-32149.

As mentioned before, synchronization acquisition performed in a case where the receiving end does not have prior knowledge of a frequency hopping pattern involves two acquisition steps including frequency hopping pattern detection and symbol timing detection. When the above-described detection technologies are used for detection of frequency hopping pattern, a trade-off should be achieved between the complexity of a detection circuit and a drop in detection precision. Further, symbol timing detection according to the related art involves an error which increases as interference due to multipath is increased in scale. When the received signal carries in itself information for identifying a frequency hopping pattern, the matched filter may be used to improve detection precision. Normally, however, the scale of matched filter is liable to increase since there are a plurality of patterns and pattern lengths (code lengths).

### SUMMARY OF THE INVENTION

The present invention has been done in view of the aforementioned circumstances and its object is to provide a synchronization acquisition circuit for a system in which information for identifying a frequency hopping pattern is transmitted as a pattern in a transmitted signal, wherein detection of a frequency hopping pattern and symbol timing are performed with a high precision, and circuit scale and power consumption are reduced at the same time.

The present invention according to one aspect provides a synchronization acquisition circuit. The synchronization acquisition circuit according to this aspect comprises: an input unit inputting a signal including a predetermined reference signal series; a derivation unit deriving a diagnosis signal series for identifying the reference signal series included in the input signal, from a plurality of candidate signal series that are candidates for match with the signal series included in the input signal; a matched filter calculating correlations between the diagnosis signal series derived and the input signal; and an identification unit identifying the reference signal series included in the input signal from the plurality of candidate signal series, based on the correlations calculated. The derivation unit may organize a plurality of taps included in a matched filter into groups, the number of groups thus defined is equal to the number of candidate signal series. The diagnosis signal series may be derived from combination of selected portions of the candidate signal series corresponding to the groups defined. The matched filter may calculate correlations for each of the groups defined. The identification unit may select groups, in accordance with the levels of correlations calculated, and cause the derivation unit and the matched filter to apply respective processes on the selected groups for a second time. The reference signal series included in the input signal may be identified by referring to the ultimately selected group.

In the apparatus described above, only a single matched filter in which a plurality of taps are organized into groups, is used. By taking of this structure, the number of candidate signal series for calculation of correlations is set to be relatively large initially and is then decreased in steps. Accordingly, detection precision is improved without inviting any increase circuit scale.

The derivation unit may store a plurality of diagnosis signal series derived from different combinations of selected portions of the plurality of candidate signal series, and output a diagnosis signal series which corresponds to the selected groups and which is selected from the plurality of diagnosis signal series stored, based on the selection of the selected groups by the identification unit. The derivation unit may define the groups such that the number of groups is decreased in steps as a result of the selection of the selected groups by the identification unit, and derives the diagnosis signal series such that the length of the selected portions of the plurality of signal series combined to form the diagnosis signal series grows longer in steps, as a result of the selection of the selected groups by the identification unit. The reference signal series included in the input signal may exhibit periodicity, and the derivation unit may define a plurality of groups, the number of which is equal to the number of representative candidate series selected from the plurality of candidate signal series, and define, after the identification unit selects a group corresponding to one of the representative candidate signal series, groups, the number of which is equal to the number of candidate signal series represented by the one of the representative candidate signal series.

The phrase “groups” refers to a predetermined number of taps derived from multiple division of a plurality of taps in a matched filter. Taps corresponding to a group may or may not be arranged in succession in the plurality of taps.

The reference signal series included in the input signal may exhibit periodicity, and the identification unit may take advantage of the periodicity to generate, for each group, a correlation for comparison, based on the correlations calculated, and pick up groups selected from the groups defined, in accordance with correlations for comparison respectively corresponding to the groups defined. The input signal may be frequency-hopped, and a frequency hopping pattern may be defined according to the reference signal series included in the input signal, and the identification unit may identify the frequency hopping pattern of the input signal, based on the reference signal series identified. The input unit may receive only a signal corresponding to a predetermined hopping frequency, of a plurality of hopping frequencies defined for the input signal. The circuit may further comprise a detection unit receiving the correlations calculated by the matched filter and corresponding to the reference signal series identified by the identification unit, and detecting timing of the input signal, based on the received correlations.

The phrase “correlation for comparison” refers to a correlation used in comparison and obtained by applying a predetermined process on the original correlation. The phrase also refers to a correlation which is identical to the original correlation.

The present invention according to another aspect provides a receiving apparatus. The receiving apparatus according to this aspect comprises: an input unit inputting a signal including a predetermined reference signal series; a derivation unit deriving a diagnosis signal series for identifying the reference signal series included in the input signal, from a plurality of candidate signal series that are candidates for match with the signal series included in the input signal; a matched filter calculating correlations between the diagnosis signal series derived and the input signal; an identification unit identifying the reference signal series included in the input signal from the plurality of candidate signal series, based on the correlations calculated; and a processing unit processing the input signal, based on the reference signal series identified, The derivation unit may organize a plurality of taps included in the matched filter into a plurality of groups, the number of the tap groups being equal to the number of the plurality of candidate signal series, and derive the diagnosis signal series by combining selected portions of the plurality of candidate signal series corresponding to the groups defined, the matched filter may calculate correlations corresponding to the groups, and the identification unit may pick up selected ones of the groups defined, in accordance with levels of the correlations calculated, cause the derivation unit and the matched filter to apply respective processes on the selected groups for a second time, and identify the reference signal series included in the input signal, by referring to the group ultimately selected.

Arbitrary combinations of the aforementioned constituting elements and implementations of the invention in the form of methods, apparatus, systems, recording mediums and computer programs may also be practiced as additional modes of the present invention.

Moreover, this summary of the invention does not necessarily describe all necessary features so that the invention may also be sub-combination of these described features.

### BRIEF DESCRIPTION OF THE DRAWINGS

FIG. 1 illustrates the structure of a communication system according to an example of the present invention.

FIGS. 2A-2D illustrate the structure of a burst format according to the example.

FIGS. 3A-3E illustrate hopping frequencies and hopping patterns according to the example.

FIG. 4 illustrates the structure of a synchronization acquisition unit of FIG. 1.

FIG. 5 illustrates the structure of a matched filter of FIG. 1.

FIG. 6 illustrates the structure of a hopping pattern detection unit of FIG. 1.

FIG. 7 illustrates the structure of a symbol timing detection unit of FIG. 1.

FIG. 8 illustrates the operation timing schedule of the synchronization acquisition unit of FIG. 1.

FIGS. 9A-9D are graphical presentations of correlations calculated by the hopping pattern detection unit of FIG. 4 in a first step.

FIGS. 10A-10D are graphical presentations of correlations calculated by the hopping pattern detection unit of FIG. 4 in a second step.

FIG. 11 is a graphical presentation of correlations calculated by the hopping pattern detection unit of FIG. 4 in a third step.

### DETAILED DESCRIPTION OF THE INVENTION

The invention will now be described based on the following examples which do not intend to limit the scope of the present invention but exemplify the invention. All of the features and the combinations thereof described in the examples are not necessarily essential to the invention.

Before describing the present invention in detail, a summary will be given. An example of the present invention relates to a communication system in which frequency hopping takes place once in every symbol. A preamble is placed at the head of a burst signal transmitted in the communication system according to the example. There are several preamble patterns available. Each of the preamble patterns is mapped into a frequency hopping pattern. By identifying a preamble pattern in a preamble block of the burst signal, a receiving apparatus is capable of acquiring a frequency hopping pattern corresponding to the preamble pattern thus identified.

The receiving apparatus according to the example identifies a preamble pattern by a matched filter. Instead of being provided with a plurality of matched filters commensurate with the number of preamble patterns, the receiving apparatus is provided with only one matched filter. For this purpose, selected ones of a plurality of taps included in a matched filter are organized into groups, where the number of selected taps is commensurate with the number of samples included in a symbol, and the number of groups thus defined is equal to the number of preamble patterns. A portion of preamble pattern is retrieved in accordance with the number of taps in each of groups. This process is a repeated for the entirety of groups. A new preamble pattern (hereinafter, referred to as a diagnosis signal series), in each of which the retrieved preamble patterns are combined, is created.

The receiving apparatus performs a process for correlation between the received signal and the diagnosis signal series. Addition of correlation is done in each group so that a plurality of partial correlations, for respective groups, are output. The levels of the plurality of correlations output are compared so as to restrict the number of groups to the number which is smaller than the number of originally defined groups. The receiving apparatus proceeds to generate a new diagnosis signal series in accordance with the restricted number of groups. A similar process is repeated until a single group is selected ultimately. The receiving apparatus identifies a preamble pattern corresponding to the single group thus selected, and identifies a frequency hopping pattern accordingly. By restricting the number of groups, the length of each of the preamble portions included in a single diagnosis signal series is extended accordingly, so that precision in correlation is improved accordingly.

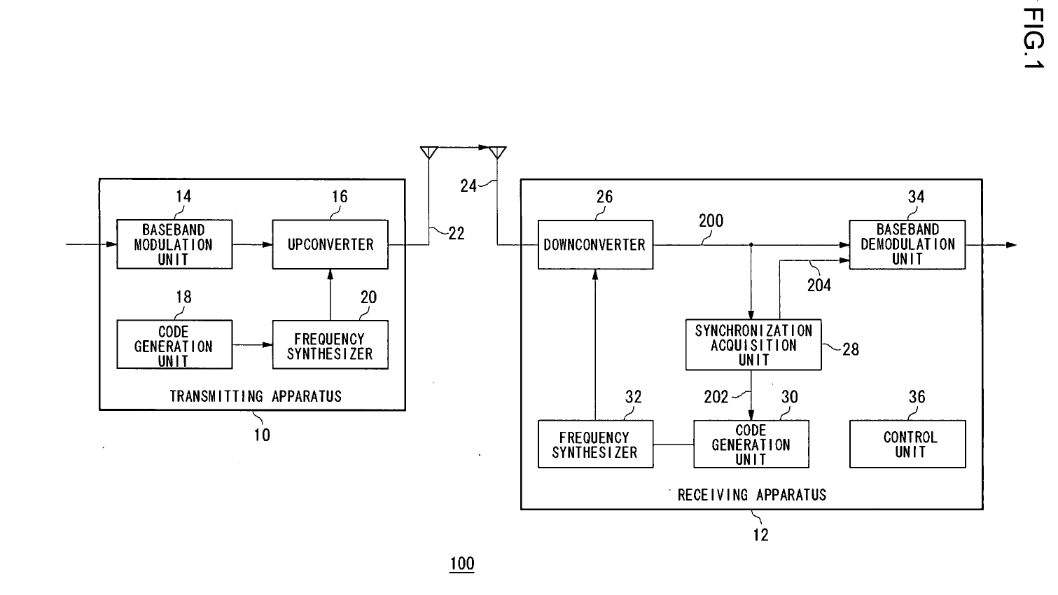

FIG. 1 illustrates the structure of a communication system 100 according to the example. The communication system 100 includes a transmitting apparatus 10 and a receiving apparatus 12. The transmitting apparatus 10 includes a baseband modulation unit 14, a upconverter 16, a code generation unit 18, a frequency synthesizer 20 and a transmitting antenna 22. The receiving apparatus 12 includes a receiving antenna 24, a downconverter 26, a synchronization acquisition unit 28, a code generation unit 30, a frequency synthesizer 32, a baseband demodulation unit 34 and a control unit 36. The receiving apparatus 12 also includes a baseband signal 200, a synchronization pattern signal 202 and a synchronization timing signal 204.

The baseband modulation unit 14 modulates a data signal in accordance with a modulation scheme such as PSK, MSK and OFDM. The code generation unit 18 generates pseudo random codes. The frequency synthesizer 20 generates randomly hopping carriers based on the pseudo random codes. The upconverter 16 subjects the modulated signal to frequency hopping using the randomly hopping carriers. The transmitting antenna 22 transmits the frequency-hopping signal. The receiving antenna 24 receives the signal transmitted from the transmitting antenna 22. The frequency synthesizer 32 generates randomly hopping carriers like the frequency synthesizer 20. The downconverter 26 subjects the received signal to frequency conversion using the randomly hopping carriers. The signal subjected to frequency conversion is output as the baseband signal 200.

If the frequency hopping pattern of the carrier generated by the frequency synthesizer 20 matches the frequency hopping pattern of the carrier generated by the frequency synthesizer 32, the downconverter 26 is capable of accurate frequency conversion of the received signal. If a match is not found, the downconverter 26 cannot succeed in frequency conversion. For accurate frequency conversion of the received signal, the synchronization acquisition unit 28 synchronizes the frequency hopping patter generated by the frequency synthesizer 32 with the frequency hopping pattern of the received signal. An instruction signal related to hopping pattern synchronization is output as the synchronization pattern signal 202. The synchronization acquisition unit 28 executed synchronization of symbol timing of the received signal and outputs an instruction signal related to symbol timing synchronization as the synchronization timing signal 204.

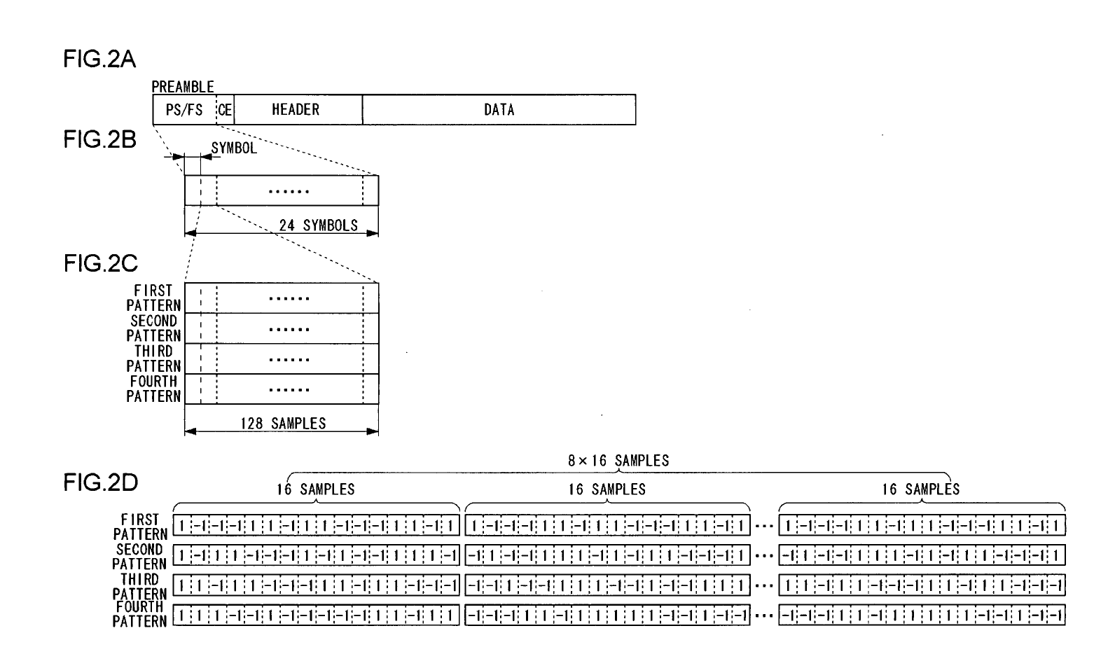

FIGS. 2A-2D illustrate the structure of a burst format according the example. FIG. 2A illustrates a burst format according to the MB-OFDM scheme. The illustration shows time on the horizontal axis. A frame is generally broken down into a preamble block, a header block and a data block. Each of the blocks is comprised of data for symbols, the number of which is defined in accordance with the communication mode. FIG. 2B illustrates the structure of preamble. A preamble is comprised of 24 symbols, each one of which is comprised of 128 samples. Since frequency hopping is conducted between one symbol to another, the same frequency continues to be used in a given symbol.

FIG. 2C illustrates a preamble pattern. In the synchronization acquisition process, the preamble block is used. Four preamble patterns orthogonal to each other are provided. The four preamble patterns will be referred to as first through fourth patterns. As mentioned, four frequency hopping patterns are defined for the four preamble patterns.

FIG. 2D illustrates the first through fourth patterns. The 128-sample signal included in a symbol is regularly organized into groups each comprising 16 samples. A symbol bit value is indicated by “1” or “−1” in the illustration. A preamble pattern includes a repetition, at a period of 16 samples, of the same signal or a sign-inverted version thereof. The values of the 16 samples differ from pattern to pattern.

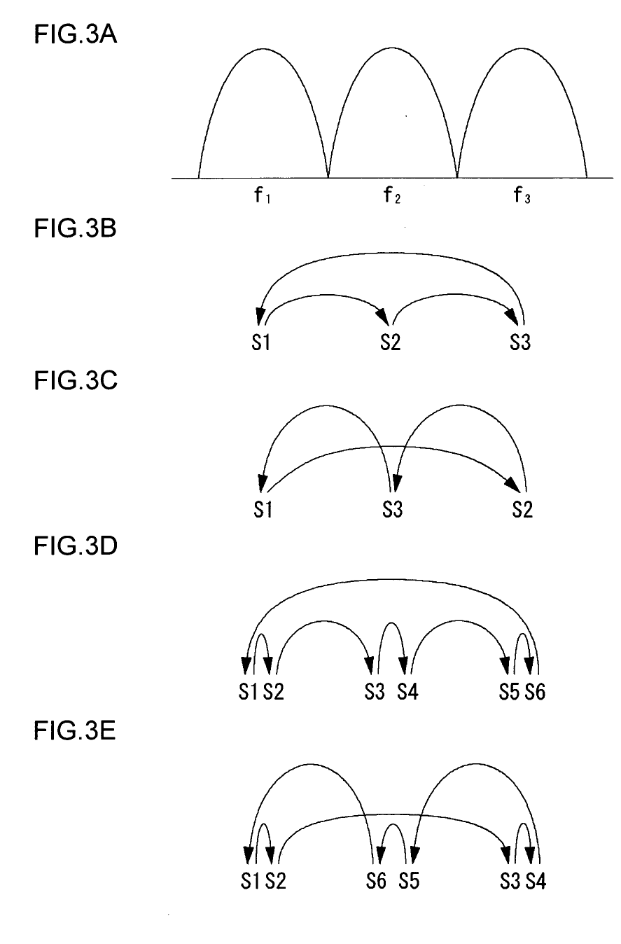

FIGS. 3A-3E illustrate hopping frequencies and hopping patterns according to the example. The illustration is intended to cover wireless personal area network (WPAN), which is known as a wireless network providing for an area smaller than that of wireless LAN and used for short-range wireless network for personal digital assistants (PDA) and peripherals. In WPAN, a speed even higher that of USB, wireless 1394 or Bluetooth is called for. MB-OFDM is known as one of the schemes to achieve this. FIG. 3A illustrates frequencies subject to hopping. In this case, frequencies “f1”, “f2” and “f3” are used. FIG. 3B illustrates a first hopping pattern, which corresponds to the first pattern of FIG. 2C. In a period of 6 symbols, the frequencies are switched such that “f1”→“f2”→“f3”→“f1”→“f2”→“f3”. Symbol timings are indicated by “S1” through “S3”.

FIG. 3C illustrates a second hopping pattern, which corresponds to the second pattern of FIG. 2C. In a period of 6 symbols, the frequencies are switched such that “f1”→“f3”→“f2”→“f1”→“f3”→“f2”. FIG. 3D illustrates a third hopping pattern, which corresponds to the third pattern of FIG. 2C. In a period of 6 symbols, the frequencies are switched such that “f1”→“f1”→“f2”→“f2”→“f3”→“f3”. FIG. 3E illustrates a fourth hopping pattern, which corresponds to the fourth pattern of FIG. 2C. In a period of 6 symbols, the frequencies are switched such that “f1”→“f1”→“f3”→“f3”→“f2”→“f2 ”.

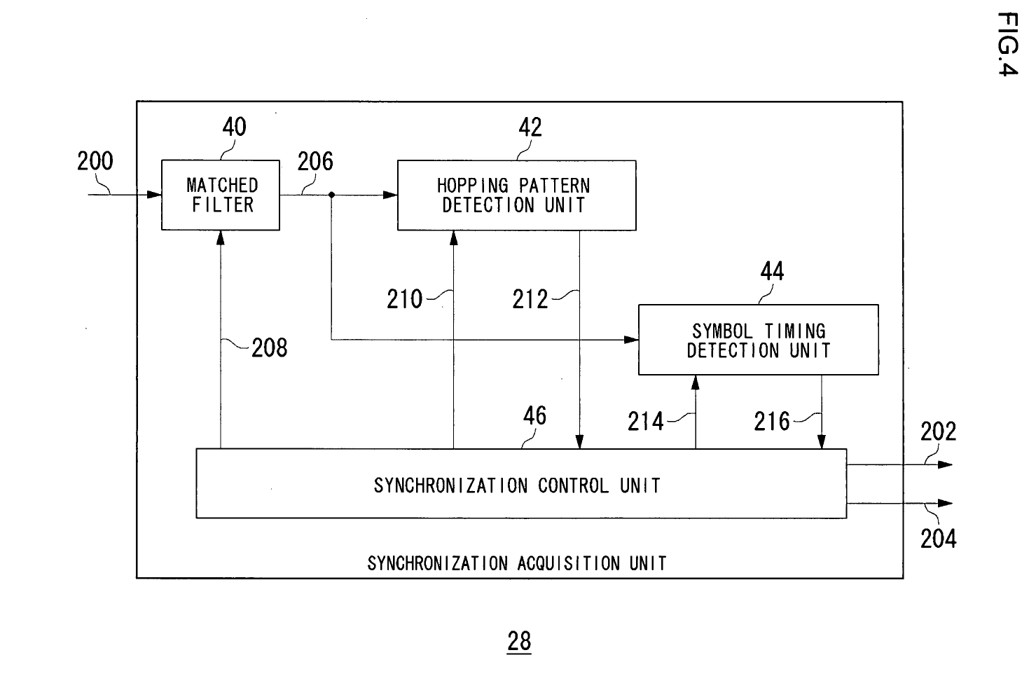

FIG. 4 illustrates the structure of the synchronization acquisition unit 28. The synchronization acquisition unit 28 includes a matched filter 40, a hopping pattern detection unit 42, a symbol timing detection unit 44 and a synchronization control unit 46. The synchronization acquisition unit 28 also includes correlations 206, a matched filter control signal 208, a hopping pattern detection unit control signal 210, a determination result 212, a symbol timing detection unit control signal 214 and a symbol timing 216.

The matched filter 40 includes a plurality of taps and calculates a correlation between the baseband signal 200 and a diagnosis signal series. The matched filter 40 receives the baseband signal 200 which includes a predetermined reference signal series, i.e. a preamble of a predetermined pattern. Of the plurality of hopping frequencies illustrated in FIG. 3A, the matched filter only receives the signal on a predetermined hopping frequency. For example, the matched filter only receives the signal on “f2”.

The matched filter 40 also derives a diagnosis signal series, based on the first through fourth preamble patterns that are candidates for a match with the preamble pattern included in the baseband signal 200. The plurality of taps included in the matched filter 40 are divided by 4, which is the number of preamble patterns, so as to define 4 groups. The diagnosis signal series is generated by combining the first through fourth patterns corresponding to the 4 groups. In order to adapt the length of the diagnosis signal series to the number of taps in the matched filter 40, only those portions of the first through fourth patterns, each having ¼ of the total pattern length, are used. The matched filter 40 calculates four correlations for the 4 groups and outputs the results of calculation as the correlations 206.

The hopping pattern detection unit 42 averages the correlations 206 output from the matched filter 40 in a symbol, and detects a frequency hopping pattern by generating and analyzing a delay profile. More specifically, the hopping pattern detection unit 42 selects groups from the groups corresponding to the preamble patterns built in the diagnosis signal series, based on the correlations 206 calculated by the matched filter 40. For example, if there are 4 groups included, the hopping pattern detection unit 42 selects 2 groups. The hopping pattern detection unit 42 outputs the selection result to the synchronization control unit 46 as the determination result 212. The synchronization control unit 46 controls the number of taps in the matched filter 40 and the diagnosis signal series, based on the determination result 212. The number of taps N defined for a single group initially is given by N=m/n where m indicates the number of samples included in a symbol, and n indicates the number of frequency hopping patterns. In the second stage, N=2 m/n. In the kth stage, N=2k-1m/n. In the following description, it is assumed that m is 128 and n is 4.

As described, the hopping pattern detection unit 42 causes the matched filter 40 to apply its process on the selected groups for a second time via the synchronization control unit 46, so as to decrease, step by step, the number of preamble patterns included in the diagnosis signal series. The hopping pattern detection unit 42 identifies the preamble pattern included in the base baseband signal, by referring to the ultimately selected one group. The synchronization control unit 46 identifies the frequency hopping pattern based on the preamble pattern thus identified.

The symbol timing detection unit 44 averages the correlations 206 output from the matched filter 40 in a symbol, and detects, step by step, the symbol timing by generating and analyzing a delay profile. It is assumed that the process in the symbol timing detection unit 44 is performed after the hopping pattern detection unit 42 identifies the one preamble pattern included in the baseband signal 200.

The construction as described above may be implemented by hardware including a CPU, a memory and an LSI and by software including a program provided with reservation and management functions loaded into the memory. Figures depict function blocks implemented by cooperation of the hardware and software. Therefore, it will be obvious to those skilled in the art that the function blocks may be implemented by a variety of manners including hardware only, software only or a combination of both.

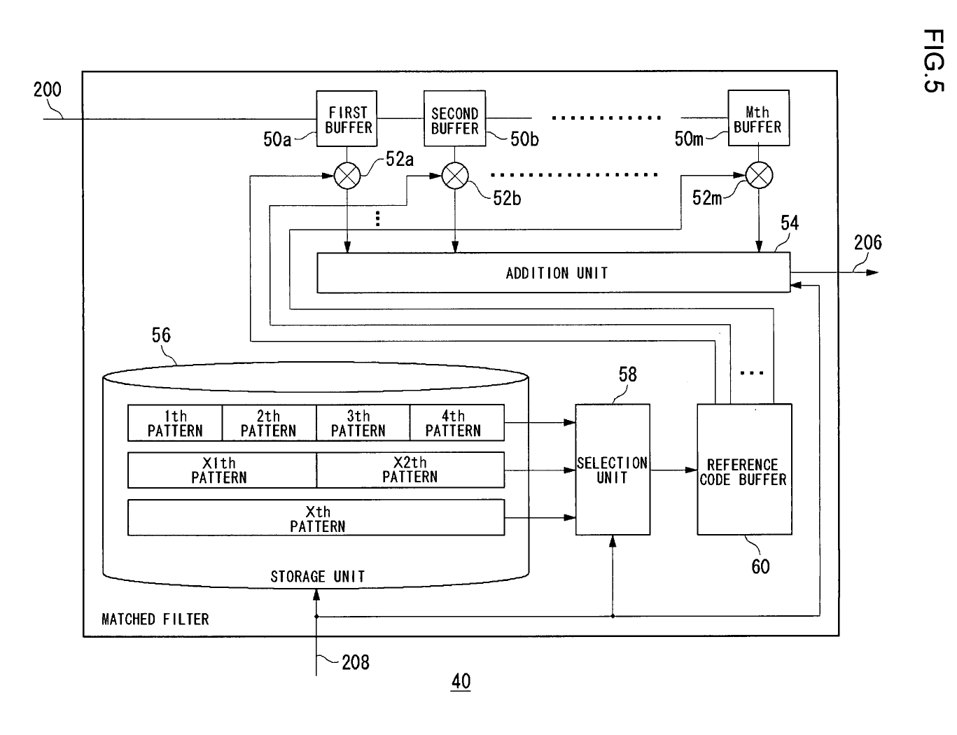

FIG. 5 illustrates the structure of the matched filter 40. The matched filter 40 includes a first buffer 50a, a second buffer 50b, an Mth buffer 50m, generically referred to as a buffer 50, a first multiplication unit 52a, a second multiplication unit 52b and an Mth multiplication unit 52m, generically referred to as a multiplication unit 52, an addition unit 54, a storage unit 56, a selection unit 58 and a reference code buffer 60.

The storage unit 56 prestores a plurality of diagnosis signal series in which preambles of different patterns are combined, or prestores preamble patterns. The storage unit 56 may store a first pattern, a second pattern, a third pattern and a fourth pattern. The storage unit 56 alternatively store a combination of the first pattern, the second pattern, the third pattern and the fourth pattern, a combination of the first pattern and the second pattern, a combination of the first pattern and the third pattern, a combination of the first pattern and the fourth pattern, a combination of the second pattern and the third pattern, a combination of the second pattern and the fourth pattern, a combination of the third pattern and the fourth pattern, the first pattern, the second pattern, the third pattern and the fourth pattern. Selection from the storage unit 56 is made such that the number of groups included in the diagnosis signal series becomes smaller in steps, in accordance with an instruction included in the matched filter control signal 208. As a result of this, the diagnosis signal series is selected such that the length of preamble combined to form the diagnosis signal series becomes extended in steps.

The selection unit 58 selects a diagnosis signal series including a corresponding group, from a plurality of diagnosis signal series stored in the storage unit 56, based on the instruction included in the matched filter control signal 208. More specifically, the selection unit 58 makes a selection from the storage unit 56 so that the combination of the first pattern, the second pattern, the third pattern and the fourth pattern is formed in a first step. In a second step, the selection unit 58 makes a selection so that one of the combination of the first pattern and the second pattern, the combination of the first pattern and the third pattern, the combination of the first pattern and the fourth pattern, the combination of the second pattern and the third pattern, the combination of the second pattern and the fourth pattern, the combination of the third pattern and the fourth pattern is formed. In a third step, the selection unit 58 selects one of the first pattern, the second pattern, the third pattern and the fourth pattern.

The baseband signal 200 is successively stored in the buffer 50. Since M=128 as mentioned before, the buffer 50 is comprised of a 128-step shift register. The diagnosis signal series selected during a search is loaded into the reference code buffer 60 in accordance with the instruction included in the matched filter control signal 208. More specifically, in the first step, as mentioned before, preamble pattern portions, each comprised of 32 chips and respectively corresponding to the first through fourth preamble patterns, are sequentially set in the reference code buffer 60. In the second step, responsive to the result of determination in the first step, preamble pattern portions, each comprised of 64 chips and corresponding to the X1th pattern and the X2 pattern selected as two candidates, are successively set in the buffer, where X1 and X2 indicate numerals between 1 and 4, X1 and X2 are different. In the third step, the preamble of 128 chips corresponding to the Xth pattern identified in the second step is set in the buffer, where X indicates a numeral between 1 and 4.

A correlation between the diagnosis signal series stored in the reference code buffer 60 and the 128 baseband signals 200 stored in the buffer 50 is calculated by the multiplication unit 52 and the addition unit 54. The multiplication unit 52 multiplies the 128 baseband signals stored in the buffer 50 by the diagnosis signal series. The addition unit 54 calculates a sum of the results of multiplication. Before the multiplication, bit “0” of the diagnosis signal series is changed to “1” and bit “1” is changed to “−1”. The addition unit 54 is controlled such that a range of addition is changed depending on the step.

In the first step, the addition unit 54 (1) calculates a sum of output vectors from the multiplication units 52 corresponding to the first buffer 50a (referred to as the first buffer 50 hereinafter) through the 32nd buffer 50, (2) calculates a sum of output vectors from the multiplication units 52 corresponding to the 33rd buffer 50 (not shown) through the 64th buffer (not shown), (3) calculates a sum of output vectors from the multiplication units 52 corresponding to the 65th buffer 50 (not shown) through the 96th buffer (not shown), (4) calculates a sum of output vectors from the multiplication units 52 corresponding to the 97th buffer (not shown) through the 128th (Mth) buffer 50, and outputs four correlations resulting from the additions in (1) through (4) as the correlations 206.

In the second step, the multiplication unit 52 (1) calculates a sum of output vectors from the multiplication units 52 corresponding to the first buffer 50 through the 64th buffer 50 (not shown), (2) calculates a sum of output vectors from the multiplication units 52 corresponding to the 65th buffer 50 (not shown) through the 128th buffer 50, and outputs two correlations resulting from additions in (1) and (2) as the correlations 206. In the third step, the output vectors from all the multiplication units 52 are added and a single correlation is output as the correlation 206.

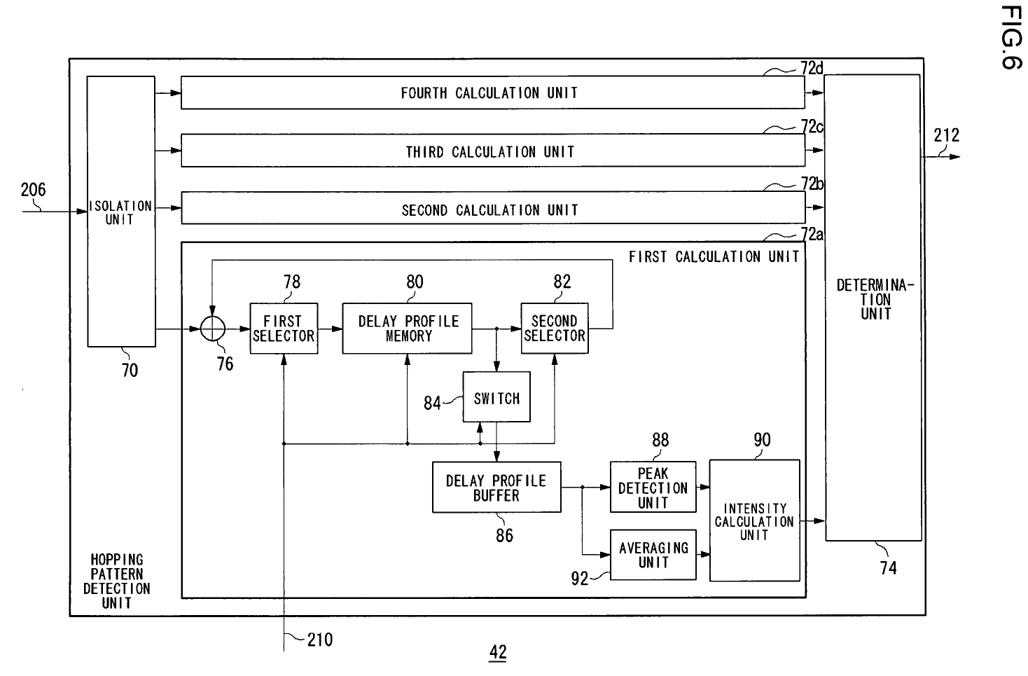

FIG. 6 illustrates the structure of the hopping pattern detection unit 42. The hopping pattern detection unit 42 includes an isolation unit 70, a first calculation unit 72a, a second calculation unit 72b, a third calculation unit 72c, a fourth calculation unit 72d, generically referred to as a calculation unit 72, and a determination unit 74. The first calculation unit 72a includes an addition unit 76, a first selector 78, a delay profile memory 80, a second selector 82, a switch 84, a delay profile buffer 86, a peak detection unit 88, an intensity calculation unit 90 and an averaging unit 92.

The isolation unit 70 isolates correlations for the first through fourth patterns, from the input correlations 206. The addition unit 76, the first selector 78, the delay profile memory 80, the second selector 82 calculates a sum of the correlations output from the isolation unit 70. Since a preamble includes a repetition at a period of 16 samples as illustrated in FIG. 2D, the correlations are added in each of 16-sample blocks, based on the periodicity of the preamble structure. The first selector 8 outputs the signal output from the addition unit 76 as data for updating the delay profile memory 80, in accordance with the hopping pattern detection unit control signal 210. Thus, the delay profile memory 80 is successively updated by the averaged synchronization error in each of 16-sample blocks. Given the time-series data for the correlations 206, started immediately after the valid correlation 206 is supplied, is {ci}(i=1, 2, 3, . . . ), an output vector from the delay profile memory 80 {AVE1, AVE2, AVE3, . . . AVE16} is as follows.

$$\begin{matrix} AVE1 = C1 + C17 + … + C113 \\ AVE2 = C2 + C18 + … + C114 \\ ⋮ \\ AVE16 = C16 + C32 + … + C128\end{matrix} \qquad ( equation 1 )$$

When the averaging is completed, the delay profile buffer 86 is turned on so that the delay profile data (AVE1-AVE16) are loaded into the delay profile buffer 86. The delay profile buffer 86 is turned off and the delay profile memory 80 is reset. The system makes a transition to creation of a delay profile for the second step. Strictly speaking, the delay profile data thus calculated result from addition in each of 16-path groups which are parts of 128 propagation paths. For this reason, no accurate information regarding delay distribution is retained. In the frequency hopping pattern detection according to the example, however, timing information is not necessary.

The peak detection unit 88 determines a maximum value PEAK_k (=max(AVE1, AVE2, . . . AVE16) of the delay profile data loaded into the delay profile buffer 86, where k is 2 or 4. The averaging unit 92 determines an average AVE_k (=(AVE1+AVE2+ . . . AVE16)/16) of the delay profile data. The intensity calculation unit 90 calculates a relative peak intensity as given below.
Relative peak intensity=max(AVE1, AVE2, . . . , AVE16)/((AVE1+AVE2+ . . . +AVE16)/16)=16*max(AVE1, AVE2, . . . , AVE16)/(AVE1+AVE2+ . . . AVE16) (equation 2)

The determination unit 74 compares the relative peak intensity levels output from the calculation unit 72 and selects a predetermined number of preamble patterns. The determination unit 74 ultimately selects one preamble pattern. More specifically, selection is made as follows. In the first step, the determination unit 74 selects two systems with the highest relative peak intensity and outputs the associated numerals (two numerals selected from 1-4) as the determination result 212. In the second step, the determination unit 74 selects a system with the larger relative peak intensity and outputs the associated numeral (one numeral selected from 1-4) as the determination result 212. The synchronization control unit 46 identifies the associated hopping pattern based on the determination result 212. The hopping pattern thus identified is output as the synchronization pattern signal 202.

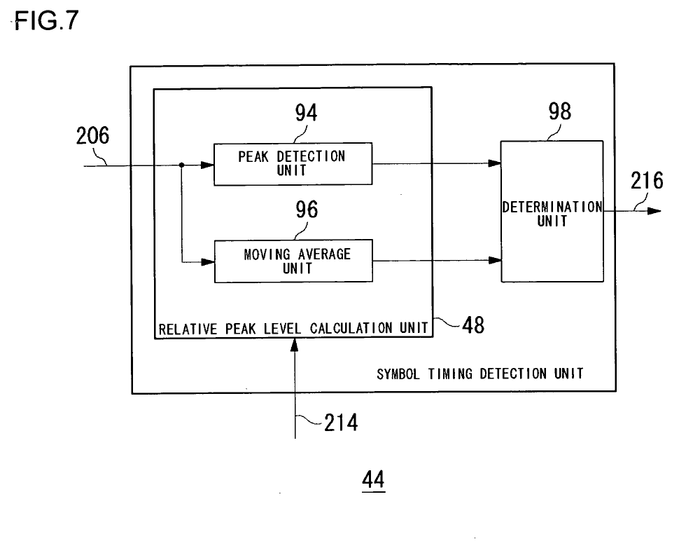

FIG. 7 illustrates the structure of the symbol timing detection unit 44. The symbol timing detection unit 44 includes a relative peak level calculation unit 48 and a determination unit 98. The relative peak level calculation unit 48 includes a peak detection unit 94 and a moving average unit 96. The symbol timing detection unit 44 receives the correlation 206 corresponding to the symbol pattern identified by the determination unit 74 so as to detect the timing of the baseband signal 200 based on the correlation 206.

The correlation 206 is supplied to the relative peak level calculation unit 48. The symbol timing detection unit control signal 214 dictates the start of the third step. The relative peak level calculation unit 48 starts its operation accordingly. The peak detection unit 94 detects a maximum value of the input correlation 206 and retains associated timing information as well as the maximum value. When the correlation input subsequently is larger than the correlation retained, a maximum value register is updated accordingly and the timing information is updated accordingly.

The correlation 206 is supplied to the moving average unit 96, which calculates a moving average of the correlations for 128 samples. When the 128 samples have been processed, the determination unit 98 calculates a relative peak level (=maximum value/moving average value) and determines whether the detection of symbol timing is completed by comparison with a threshold value. When it is determined that the relative peak level is below the threshold value and does not satisfy a condition for determination of completion of detection, the process on 128 samples is continued through the subsequently received symbols.

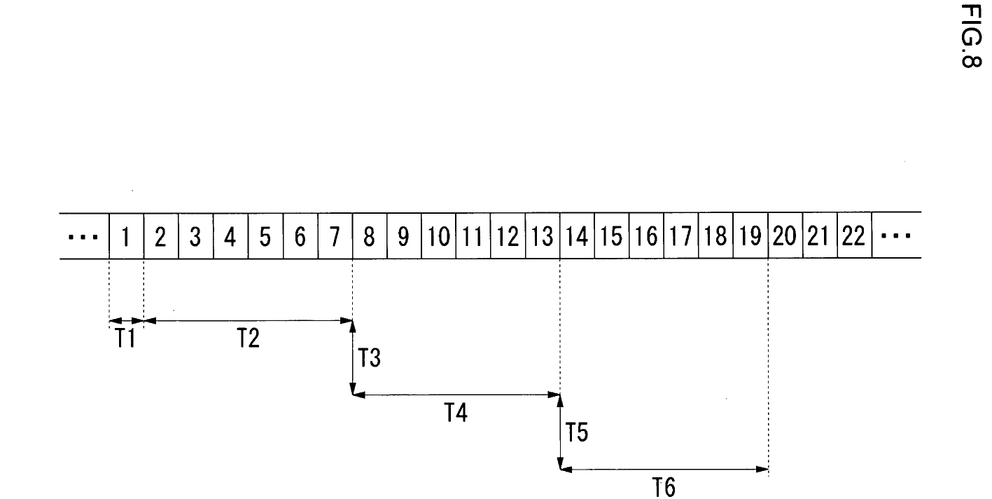

FIG. 8 illustrates the operation timing schedule of the synchronization acquisition unit 28. FIG. 8 shows time on the horizontal axis and presents relationship between a received preamble signal and steps in the synchronization acquisition process. The preamble signal is illustrated as blocks each representing a symbol. Separation between the blocks is according to the timing schedule of the matched filter 40 operation so that inter-symbol boundaries are imaginary ones.

“T1” indicates a period in which the buffer 50 of the matched filter 40 is filled. “T2” indicates a period in which the matched filter 40 is operated in the first step to output the valid correlations 206. “T3” indicates a period in which the hopping pattern detection unit 42 identifies candidates for frequency hopping pattern in the first step. Two candidates are selected. “T4” indicates a period in which the matched filter 40 is operated in the second step to output the valid correlations 206. “T5” indicates a period for frequency hopping pattern detection in the second stage. “T6” indicates a period in which the matched filter 40 is operated to output the valid correlation 206. Symbol timing detection by the symbol timing detection unit 44 is performed for each symbol in the period “T6”.

These processes, which end in symbol timing detection, are completed in a preamble period of 19 symbols. As illustrated in FIG. 2C, the preamble used in synchronization acquisition is comprised of 24 symbols. Since synchronization acquisition is completed in a 19-symbol period according to the example, the required processes are completed within the prescribed preamble period.

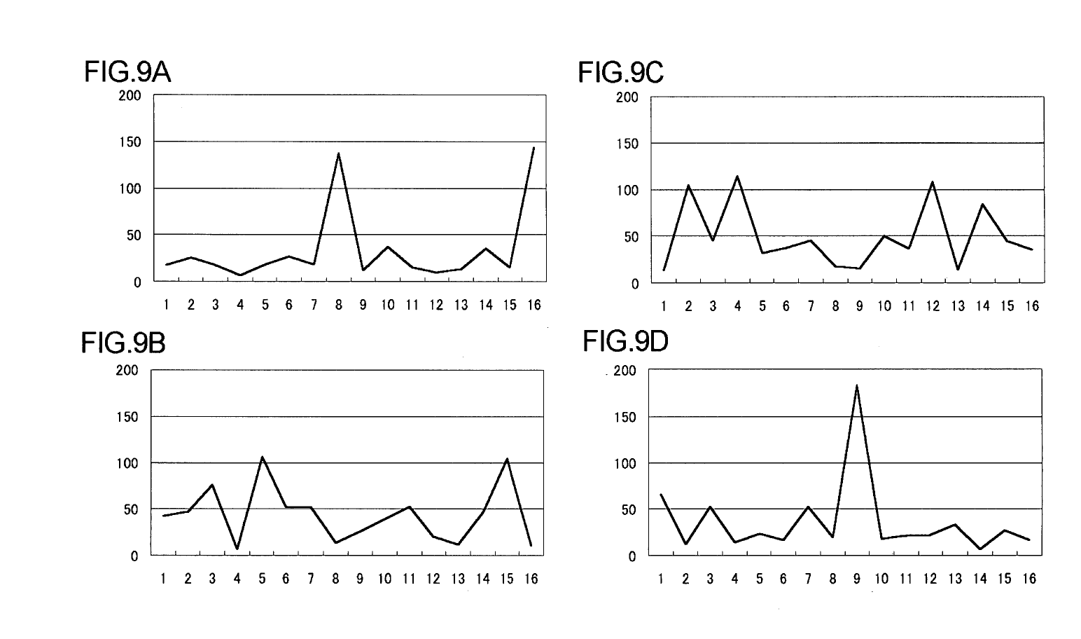

FIGS. 9A-9D are graphical presentations of correlations calculated by the hopping pattern detection unit 42 in the first step. The graphs show waveforms of the outputs from the delay profile buffer 86 in the first step. FIGS. 9A-9D present correlations between the first through fourth preamble patterns corresponding to the frequency hopping pattern of the transmitted signal, and the baseband signal 200. Each of the plotted correlations is a partial correlation for 32 samples. FIGS. 9A and 9D each shows a large relative peak intensity. The determination unit 74 outputs an instruction signal dictating that the first pattern and the fourth pattern be selected as a result of selection in the first step.

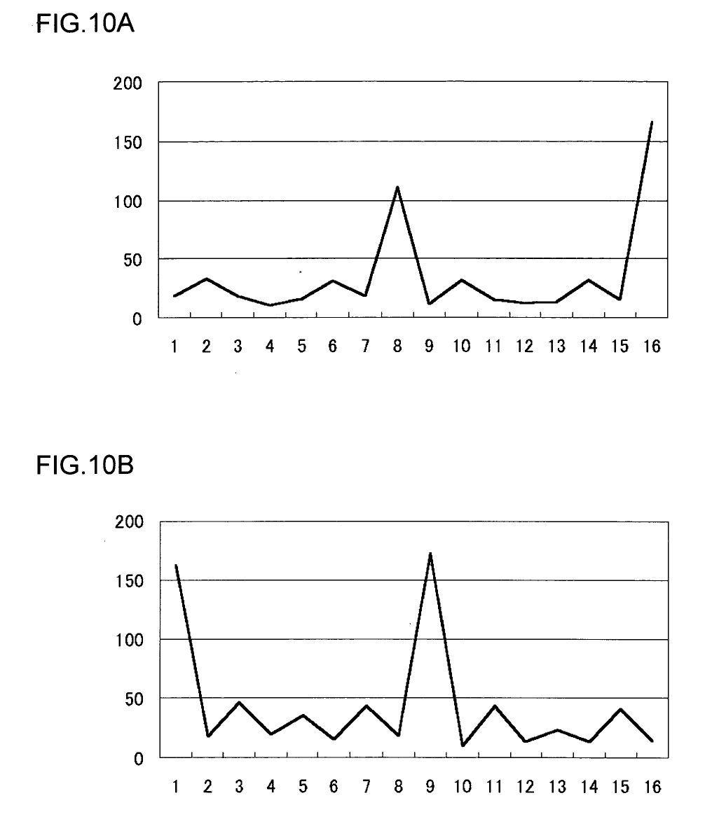

FIGS. 10A-10B are graphical presentations of correlations calculated by the hopping pattern detection unit 42 in the second step. The graphs show waveforms of output from the delay profile buffer 86 in the second step. FIGS. 10A-10B present correlations between the first and fourth preamble patterns corresponding to the frequency hopping pattern of the transmitted signal, and the baseband signal 200. Each of the plotted correlations is a partial correlation for 64 samples. FIG. 10A shows the larger relative peak intensity. The determination unit 74 outputs an instruction signal dictating that the first pattern be selected as a result of selection in the second step.

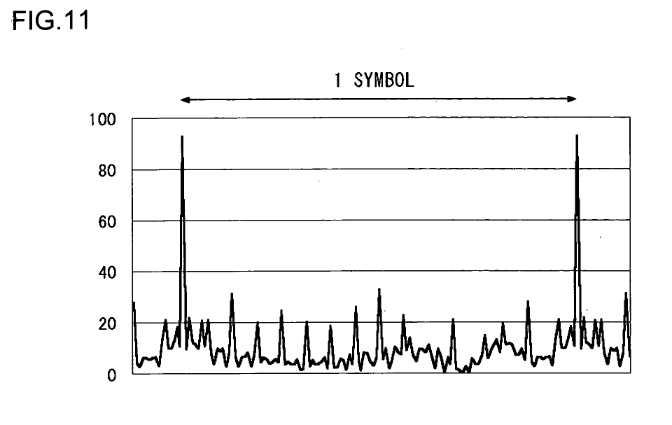

FIG. 11 is a graphical presentation of correlation calculated by the hopping pattern detection unit 42 in the third step. The graph shows a waveform output from the matched filter 40 of 128 taps. Correlation peaks are observed to appear at a period of one symbol. The peak position enables calculation of symbol boundary timing.

A description will now be given of the operation of the synchronization acquisition unit 28 with the above-described structure. The reference code buffer 60 receives a diagnosis signal series in which four patterns are combined. The matched filter 40 calculates four types of correlations between the baseband signal 200 and the diagnosis signal series, so as to output the correlations 206. The hopping pattern detection unit 42 determines the relative levels of the four types of correlations and selects two patterns based on the relative levels. The reference code buffer 60 receives the diagnosis signal series in which two patterns are combined. The matched filter 40 calculates two types of correlations between the baseband signal 200 and the diagnosis signal series, so as to output the correlations 206. The hopping pattern detection unit 42 determines the relative levels of the two types of correlations and selects one pattern based on the relative levels. The reference code buffer 60 receives a diagnosis signal series comprising a single pattern. The matched filter 40 calculates a correlation between the baseband signal and the diagnosis signal series, so as to output the correlation 206. The symbol timing detection unit 44 establishes timing synchronization by detecting a peak in relative intensity of the correlation 206. Also, the frequency hopping pattern is identified based on the selected one pattern.

According to the example of the present invention, the matched filter is partitioned in its use. Candidates for a matching pattern are narrowed down by determination on the relative intensity levels of correlations, using a shortened period for correlation. The period for correlation is successively extended in steps so that a single preamble pattern is ultimately identified by determination on the relative intensity level of correlations in the steps. In this way, a synchronization acquisition scheme which excels in detection precision and detection time and which requires only the resources of a single matched filter, is delivered. In contrast with a scheme in which a plurality of matched filters are used, the circuit scale and power consumption are reduced. In a system in which information for identifying a frequency hopping pattern is transmitted as pattern in a transmitted signal, detection of a frequency hopping pattern and symbol timing are performed with a high precision, and circuit scale and power consumption are reduced at the same time.

Described above is an explanation of the present invention based on the embodiment. The description of the embodiment is illustrative in nature and various variations in constituting elements and processes involved are possible. Those skilled in the art would readily appreciate that the variations are also within the scope of the present invention.

According to the described example of the present invention, the storage unit 56 the selection unit 58, the reference code buffer 60 are operated such that they derive diagnosis signal series from combination of four preamble patterns, then derive diagnosis signal series from combination of two preamble patterns, and then derive a diagnosis signal series comprising the one preamble pattern. Alternatively, a preamble pattern may be identified in a pattern different from the pattern in the example, by taking advantage of the periodicity of preamble pattern. There may be defined groups, the number of which is equal to the number of representative preamble patterns selected from the plurality of preamble patterns. A process similar to that of the described example may be performed to select a representative preamble pattern and then pinpoint a single preamble pattern from a plurality of preamble patterns represented by the selected representative pattern.

More specifically, the preamble patterns shown in FIG. 2D indicate that, in the first step, discrimination between the first pattern and the fourth pattern is difficult, and discrimination between the second pattern and the third pattern is difficult. For this reason, the first pattern and the second pattern are selected as representative patterns. After selecting one of these, selection is made in the patterns represented by the selected pattern. For example, when the first pattern is selected, selection between the first pattern and the fourth pattern is then made. More specifically, a diagnosis signal series in which two preamble patterns are combined is derived, and a diagnosis signal series in which two preamble patterns are combined is further derived. After that, a diagnosis signal series comprising only one preamble pattern is derived. According to the variation described above, the number of samples in each of preamble patterns combined to form the diagnosis signal series in the first step is increased so that precision correlation is improved. The requirement is that selection of a single pattern from a plurality of patterns is made in steps.

According to the example of the present invention, the intensity calculation unit 90 calculates the relative peak intensity using division. Alternatively, the relative peak intensity may be calculated using subtraction or the like. For example, the relative peak intensity may be given by the following equation.
Relative peak intensity=max(AVE1, AVE2, . . . , AVE16)−(AVE1+AVE2+ . . . +AVE16)/16) (equation 3)

According to the variation described above, circuit scale is reduced. The requirement is that effects from noise, etc. are factored in the calculation of relative intensity.

In the example of the present invention, one matched filter 40 is used in the synchronization acquisition unit 28. Alternatively, two matched filters may be used so as to extend the period for correlation by a factor of 2. According to the variation described above, precision is improved. The requirement is that the number of partitions in a matched filter may be optimized in accordance with the required period for correlation (length of reference code), the number of frequency hopping patterns and time that can be consumed for acquisition of synchronization.

Although the present invention has been described by way of exemplary embodiments, it should be understood that many changes and substitutions may further be made by those skilled in the art without departing from the scope of the present invention which is defined by the appended claims.

1. A synchronization acquisition circuit comprising:
an input unit inputting a signal including a predetermined reference signal series;
a derivation unit deriving a diagnosis signal series for identifying said reference signal series included in said input signal, from a plurality of candidate signal series that are candidates for match with said signal series included in said input signal;
a matched filter calculating correlations between the diagnosis signal series derived and said input signal; and
an identification unit identifying said reference signal series included in said input signal from said plurality of candidate signal series, based on said correlations calculated, wherein
said derivation unit organizes a plurality of taps included in said matched filter into a plurality of groups, the number of the tap groups being equal to the number of said plurality of candidate signal series, and derives the diagnosis signal series by combining selected portions of said plurality of candidate signal series corresponding to said groups defined,
said matched filter calculates correlations corresponding to said groups, and
said identification unit picks up selected ones of said groups defined, in accordance with levels of said correlations calculated, causes said derivation unit and said matched filter to apply respective processes on said selected groups for a second time, and identifies the reference signal series included in said input signal, by referring to the group ultimately selected.

2. The synchronization acquisition circuit according to claim 1, wherein said derivation unit stores a plurality of diagnosis signal series derived from different combinations of selected portions of said plurality of candidate signal series, and outputs a diagnosis signal series which corresponds to said selected groups and which is selected from said plurality of diagnosis signal series stored, based on the selection of said selected groups by said identification unit.

3. The synchronization acquisition circuit according to claim 1, wherein said derivation unit defines said groups such that the number of groups is decreased in steps as a result of the selection of said selected groups by said identification unit, and derives the diagnosis signal series such that the length of said selected portions of said plurality of signal series combined to form the diagnosis signal series grows longer in steps, as a result of the selection of said selected groups by said identification unit.

4. The synchronization acquisition circuit according to claim 2, wherein said derivation unit defines said groups such that the number of groups is decreased in steps as a result of the selection of said selected groups by said identification unit, and derives the diagnosis signal series such that the length of said selected portions of said plurality of signal series combined to form the diagnosis signal series grows longer in steps, as a result of the selection of said selected groups by said identification unit.

5. The synchronization acquisition circuit according to claim 1, wherein the reference signal series included in said input signal exhibits periodicity, and
said derivation unit defines a plurality of groups, the number of which is equal to the number of representative candidate series selected from said plurality of candidate signal series, and defines, after said identification unit selects a group corresponding to one of said representative candidate signal series, groups, the number of which is equal to the number of candidate signal series represented by said one of said representative candidate signal series.

6. The synchronization acquisition circuit according to claim 2, wherein the reference signal series included in said input signal exhibits periodicity, and
said derivation unit defines a plurality of groups, the number of which is equal to the number of representative candidate series selected from said plurality of candidate signal series, and defines, after said identification unit selects a group corresponding to one of said representative candidate signal series, groups, the number of which is equal to the number of candidate signal series represented by said one of said representative candidate signal series.

7. The synchronization acquisition circuit according to claim 3, wherein the reference signal series included in said input signal exhibits periodicity, and
said derivation unit defines a plurality of groups, the number of which is equal to the number of representative candidate series selected from said plurality of candidate signal series, and defines, after said identification unit selects a group corresponding to one of said representative candidate signal series, groups, the number of which is equal to the number of candidate signal series represented by said one of said representative candidate signal series.

8. The synchronization acquisition circuit according to claim 4, wherein the reference signal series included in said input signal exhibits periodicity, and
said derivation unit defines a plurality of groups, the number of which is equal to the number of representative candidate series selected from said plurality of candidate signal series, and defines, after said identification unit selects a group corresponding to one of said representative candidate signal series, groups, the number of which is equal to the number of candidate signal series represented by said one of said representative candidate signal series.

9. The synchronization acquisition circuit according to claim 1, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

10. The synchronization acquisition circuit according to claim 2, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

11. The synchronization acquisition circuit according to claim 3, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

12. The synchronization acquisition circuit according to claim 4, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

13. The synchronization acquisition circuit according to claim 5, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

14. The synchronization acquisition circuit according to claim 6, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

15. The synchronization acquisition circuit according to claim 7, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

16. The synchronization acquisition circuit according to claim 8, wherein the reference signal series included in said input signal exhibits periodicity, and
said identification unit takes advantage of said periodicity to generate, for each group, a correlation for comparison, based on said correlations calculated, and picks up groups selected from said groups defined, in accordance with correlations for comparison respectively corresponding to said groups defined.

17. The synchronization acquisition circuit according to claim 1, wherein said input signal is frequency-hopped, and a frequency hopping pattern is defined according to the reference signal series included in said input signal, and said identification unit identifies the frequency hopping pattern of said input signal, based on the reference signal series identified.

18. The synchronization acquisition circuit according to claim 17, wherein said input unit receives only a signal corresponding to a predetermined hopping frequency, of a plurality of hopping frequencies defined for said input signal.

19. The synchronization acquisition circuit according to claim 1, further comprising a detection unit receiving the correlations calculated by said matched filter and corresponding to the reference signal series identified by said identification unit, and detecting timing of said input signal, based on the received correlations.

20. A receiving apparatus comprising:
an input unit inputting a signal including a predetermined reference signal series;
a derivation unit deriving a diagnosis signal series for identifying said reference signal series included in said input signal, from a plurality of candidate signal series that are candidates for match with said signal series included in said input signal;
a matched filter calculating correlations between the diagnosis signal series derived and said input signal;
an identification unit identifying said reference signal series included in said input signal from said plurality of candidate signal series, based on said correlations calculated; and
a processing unit processing said input signal, based on the reference signal series identified, wherein
said derivation unit organizes a plurality of taps included in said matched filter into a plurality of groups, the number of the tap groups being equal to the number of said plurality of candidate signal series, and derives the diagnosis signal series by combining selected portions of said plurality of candidate signal series corresponding to said groups defined,
said matched filter calculates correlations corresponding to said groups, and
said identification unit picks up selected ones of said groups defined, in accordance with levels of said correlations calculated, causes said derivation unit and said matched filter to apply respective processes on said selected groups for a second time, and identifies the reference signal series included in said input signal, by referring to the group ultimately selected.
